(19) United States
(12) Patent Application Publication
(10) Pub. No.: US 2016/0162532 A1
(43) Pub. Date: Jun. 9, 2016

(54) DIGITAL CONTENT AGGREGATION FROM MULTIPLE SOURCES

(71) Applicant: Microsoft Technology Licensing, LLC, Redmond, WA (US)

(72) Inventors: Yu Zhang, Redmond, WA (US); Sacrajit Ganguly, Redmond, WA (US); Swamynathan Subramanian, Redmond, WA (US)

(21) Appl. No.: 14/564,403

(22) Filed: Dec. 9, 2014

(51) Int. Cl. G06F 17/30

(52) U.S. Cl. CPC G06F 17/30362; G06F 17/30371

(57) ABSTRACT

Embodiments are directed to aggregating content from a plurality of sources and to applying exclusive locks to portions of content on distributed systems. In one scenario, a computer system accesses content from at least two different content sources. The computer system validates the accessed content and determines that the accessed portions of content are related to at least one version of a specified item. This specified item is to be presented in a user interface along with the accessed portions of content from the at least two different content sources. The computer system then merges the accessed portions of content into an aggregated representation of the specified item which is displayable in the user interface.

### BACKGROUND

The growth of mobile computing systems such as phones and tablets has been enormous. As these mobile devices have proliferated, so to has the need for software applications, commonly referred to as “apps”. These apps are often provided within an app store that allows users to read reviews about the app, analyze its features and make a determination as to whether to pay for and/or download the app. Similarly, millions of other products or other items are presented and sold on retailer websites. Each of these goods has an associated description, price, and likely user reviews. Each type of content related to the goods, app or other items may come from an internal source, or may come from many different internal and/or external sources.

### BRIEF SUMMARY

Embodiments described herein are directed to aggregating content from a plurality of sources and to applying exclusive locks to portions of content on distributed systems. In one embodiment, a computer system accesses content from at least two different content sources. The computer system validates the accessed content and determines that the accessed portions of content are related to at least one version of a specified item. This specified item is to be presented in a user interface along with the accessed portions of content from the at least two different content sources. The computer system then merges the accessed portions of content into an aggregated representation of the specified item which is displayable in the user interface. This allows publishers from multiple sources to publish content independent of each other, while the computer system merges them together using a common identifier. This provides a simple and robust solution for aggregating content from multiple publishers.

In another embodiment, a computer system performs a method for applying exclusive locks to portions of content on a distributed system. The computer system receives data in a data stream and provides an indication to a storage device indicating that a specified function is to be performed in response to the received data. Then, upon initiating the specified function, the computer system updates state information corresponding to the specified function in a data structure and either determines that the specified function completed successfully and deletes the state information, or determines that the specified function failed to complete successfully and reverts the state information to its original state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including aggregating content from a plurality of sources.

FIG. 2 illustrates a flowchart of an example method for aggregating content from a plurality of sources.

FIG. 3 illustrates a flowchart of an example method for applying exclusive locks to portions of content on distributed systems.

FIG. 4 illustrates an embodiment in which data is received in a data stream and exclusive locks are applied to the data on distributed systems.

FIG. 5 illustrates an embodiment of a user interface in which an aggregated representation of data is presented.

FIG. 6A illustrates a data structure in which state information has been deleted.

FIG. 6B illustrates a data structure in which state information has reverted to its original state.

### DETAILED DESCRIPTION

Embodiments described herein are directed to aggregating content from a plurality of sources and to applying exclusive locks to portions of content on distributed systems. In one embodiment, a computer system accesses content from at least two different content sources. The computer system validates the accessed content and determines that the accessed portions of content are related to at least one version of a specified item. This specified item is to be presented in a user interface along with the accessed portions of content from the at least two different content sources. The computer system then merges the accessed portions of content into an aggregated representation of the specified item which is displayable in the user interface. By combining the different portions of content into a single aggregated representation, a potential viewer would be able to conveniently view multiple pieces of related content without having to consume bandwidth or processing resources to search for the related content. Moreover, the potential viewer would enjoy improved user interaction with the item as its related content would be displayed in close proximity to the item.

In another embodiment, a computer system performs a method for applying exclusive locks to portions of content on distributed systems. The computer system receives data in a data stream and provides an indication to a storage device indicating that a specified function is to be performed in response to the received data. Then, upon initiating the specified function, the computer system updates state information corresponding to the specified function in a data structure and either determines that the specified function completed successfully and deletes the state information, or determines that the specified function failed to complete successfully and reverts the state information to its original state.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

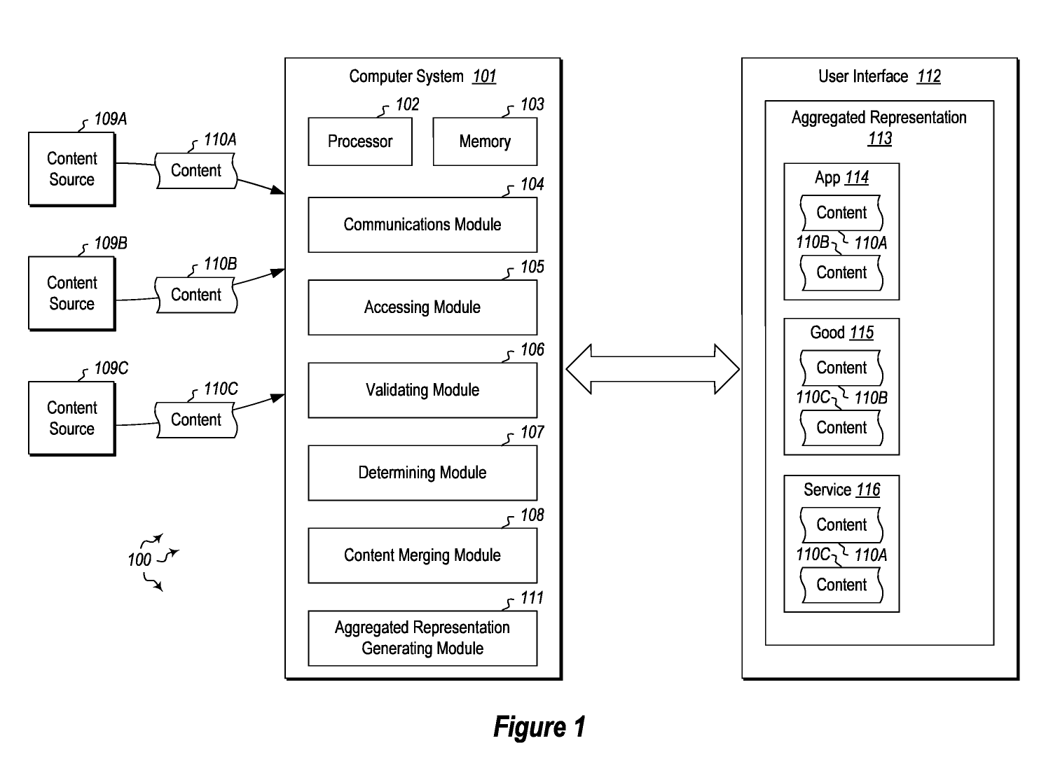

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The communications module 104 may further be configured to receive content from various content sources. This content (e.g. 110A, 110B, or 110C) may be any type of textual information, graphics, documents, presentations, pictures, videos, web pages, aggregated information received from other sources or any other type of informational content which may be presented to a user. In one embodiment, the content may be related to a specific application, good or service. For example, content portions 110A and 110B may be related to application 114 and, as such, may be presented next to application 114 in the aggregated view or aggregated representation 113. Similarly, content 110B and content 110C may be related to good 115 and may presented along with that good, and content 110A and content 110C may be related to service 116 and may be presented along with that service. Thus, it can be seen that some content portions are aggregated to one application, while other content portions are aggregated to multiple applications. It will be understood that the application 114, good 115 and service 116 are merely examples of items to which content may be related, and that substantially any item may be presented in an aggregate representation. Similarly, while certain portions of content have been illustrated as being related to multiple items, some content may only relate to a single item.

Each portion of content (e.g. 110A-110C) may be received from a different source (e.g. 109A, 109B or 109C), or may be received from the same source. The content sources may include, for example, content from various departments of a corporation or from different third party companies. These content sources may include marketing departments or firms, ratings or reviews, licensing information, sales information, user-targeted information or other types of information. Each portion of content may be merged with the other received portions of content by the content merging module 108 of computer system 101. The aggregated representation generating module 111 of computer system 101 may then generate the aggregated representation 113 that is displayed in user interface 112. It will be understood that the user interface (UI) 112 may be shown on any type of display, including on a laptop or PC monitor, on a tablet, smart phone, wearable device or any other device that has a display screen.

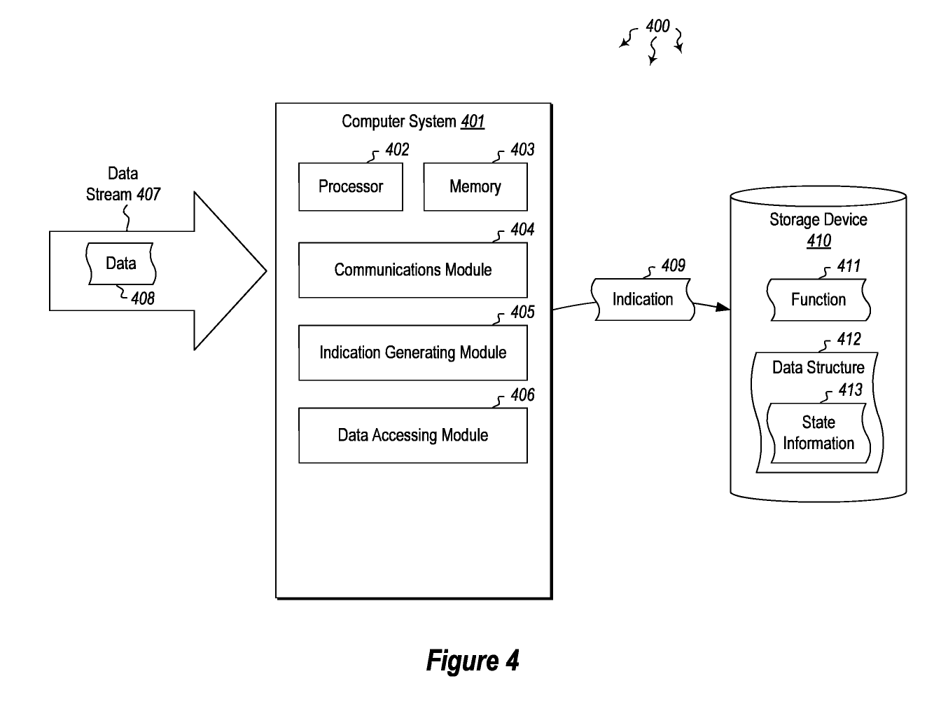

Thus, in this manner, content from many different sources can be aggregated and presented to the user in an organized view. In some embodiments, content may be aggregated and presented in a marketplace that is offering applications or “apps”, goods or services for sale. Multiple sources of content or content authorities collaborate to provide comprehensive offerings. For instance, a publisher may provide metadata about a good, service or app, a business may define the pricing for certain markets, partners or existing channels may provide additional channels, discount, or subscriptions, enterprises may apply additional bulk purchasing discount or constraints, external agencies may supply marketing images, campaign, rating, usage etc. Each type of content may come in to communications module 104 as a live data stream (as shown in FIG. 4) during runtime from different sources. As such, aggregation is to be performed and reflected accurately and timely, resolving potential conflicts based on defined business rules.

To have a network of content producers collaboratively provide portion of data for same content may be very useful for small to medium size developers and publishers. These types of entities may not be able to afford to have their own finance, marketing or other departments, and hence may have disadvantages competing with larger publishers. Large enterprises and educational entities may also implement the embodiments described herein. For example, a developer can write the same application and offer to different targeted enterprises or schools and present a unique, tailored experience in the aggregated presentation 113. For instance, the developer may provide a paid app in retail and free or discounted version for schools. The enterprise or premium edition may be offered in the marketplace with multiple and extensive features, while the educational edition may include less features. Being able to provide unique and differentiable representations may be very appealing to enterprise and education entities alike.

Different aspects of content (or simply “data” herein) may be provided by multiple sources for the same item (e.g. app, good, service, etc.). Embodiments described herein provide various partition mechanisms to support different business needs. Two partition mechanisms are described: static and dynamic. Static partitioning uses a full or partial content identifier as reference. For example, an enterprise volume purchase could define a different data scheme to allow pushing the same retail app into an enterprise store. Its data could use the retail app identifier as part of its corresponding data partition key so that it can “reference” the same app in the enterprise store. When a developer subsequently upgrades or extends the features of the app, the enterprise store will automatically get latest app. In another example, an agency provides user images or localized content for the same application. The agency can use the partition key as an app identifier, so that in the aggregated view of app, the consumer can see professionally produced images and localized content blended with app in the aggregated view 113.

Dynamic partitioning uses conditional references or computed references. For example, in some embodiments, an advertising agency may ingest advertisements into apps only when the app's pricing reaches a certain level or when the number of user downloads has hit a predefined threshold. The data can be pre-created by an agency and get referenced or reflected in the aggregated view 113 when those conditions are met. In another example, a social network may provide a user's friends or groups recommendations on the same app only when the user logs in through their platform.

Embodiments described herein may further provide syntax or a taxonomy expression of partitioning as well as extension plug-in for custom partitioning. A partitioning component may be provided to manage and/or compute partitioning referencing. Embodiments may further provide processors or processing threads to perform various functions. The processors can look up and merge partitioned data into final aggregated data for the item. These processors can perform data transformation and aggregation using specific business logic through a common interface so that it can be extended or plugged in dynamically.

For example, a school education processor may only look for educational type of content (e.g. a video app or an e-reading app) and may provide appropriate grade level information that can be aggregated and presented in the aggregated view 113. These processors can be linked together with or without ordering. For example, a finance department's offer data for the same content may only be aggregated after the business department's rating has been created for the item. Embodiments herein provide definitions of custom workflows for chaining the processors together. Embodiments may also support multiple parallel versioning of data aggregation. The same content may be represented in separate forms for each version and consumed independently. For example, the same app can have a basic version with a free app and in app-ads provided from separate sponsor data, or a premium paid version without ads.

Embodiments may also enable live data stream runtime online or offline aggregation of multiple parallel data streams. These embodiments may deploy distributed agents which host the partitioning component and processors to detect incoming live data streams and process the data streams based on priority, partition, content type or custom defined classification in real time to aggregate data for the same application, good, service or other item. The data may be aggregated to an output stream which will be consumed by downstream systems in massive scale. For example, a school reading app can show curriculum as well as any matched videos (potentially millions of videos from different content sources) matching selected criteria. In another example, a retail app may show aggregated matched reviews from billions of entries in social networks in real time.

Embodiments provided herein may also support offline aggregation using snapshots of the latest known good data streams. For instance, if a user device is offline, the item will be shown in the aggregated view 113 in its last known aggregated state. A data store may store the latest snapshot when user is online and, as soon as the user is back online, the computer system 101 will detect the time gap and push the latest aggregated view to the user. A distributed agent may apply an exclusive optimistic lock for each content identifier. In some cases, multiple agents or within same agent, multiple processors will perform aggregation on the same app, good, service or other item. To avoid content corruption or overriding, the agent may use an optimistic lock that allows actions to be performed in parallel and maintain hashed signatures on content to ensure integrity.

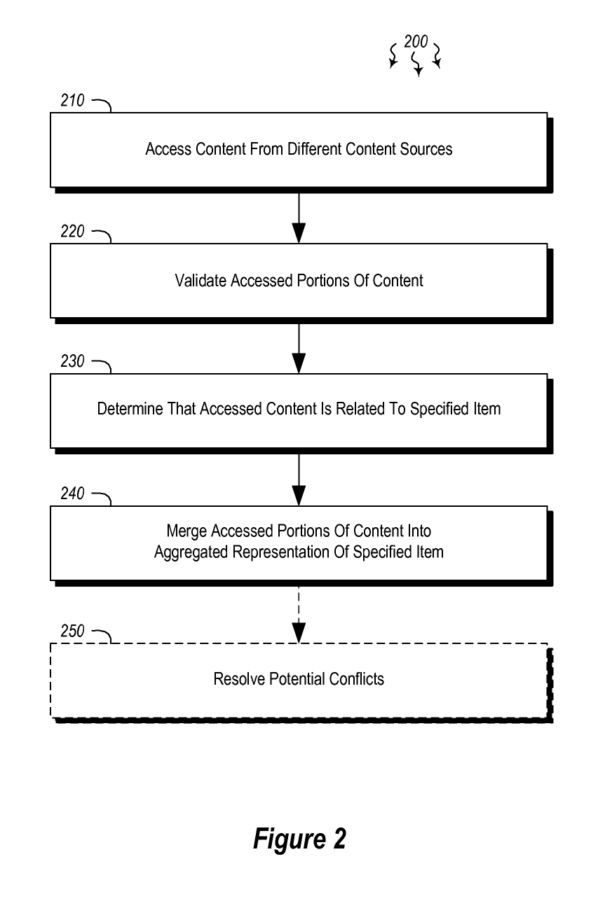

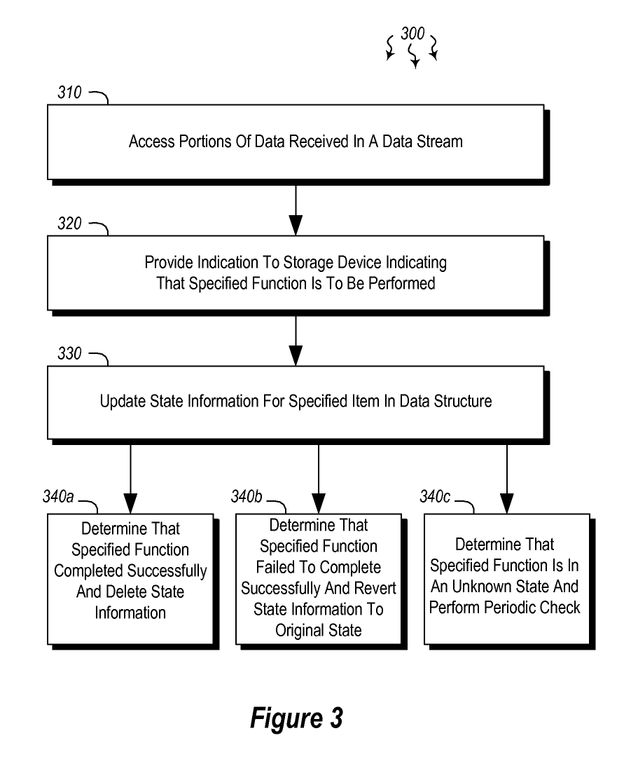

When conflicts arise, embodiments provided herein can define the conflict detection rules and implement agents to catch multiple content sources providing conflicting data on the same partition or section for the same item. Each segment of data eligible for aggregation by multiple processors will be tagged with versioning. A data analyzer may be used to detect those multi-version properties and, based on custom defined syntax or taxonomy, may initiate data reconciliation. For instance, a developer may set a rating of application for all ages. If an external agency provides age rating images based on a mature rating for the app, the system will detect the discrepancy and take proper actions to reconcile the conflict. Still further, embodiments may be configured to define the conflict reconciliation rules and implement agents to automatically resolve conflicts or notify users for manual intervention. For example, a developer may publish an app with a genre listed as “entertainment”, a video provider may supply trailer data for same app as “action”, “teaching” and “fun”. In such cases, a data reconciliation filter could filter out the “teaching” part of data and apply the most suitable portion of data to be aggregated. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for aggregating content from a plurality of sources. The method 200 will now be described with frequent reference to the components and data of environment 100.

Method 200 includes accessing one or more portions of content from at least two different content sources (210). For example, the accessing module 105 of computer system 101 may access content 110A from content source 109A, content 110B from content source 109B and/or content 110C from content source 109C, or any other content from any other source not shown. The content may be received as individual portions of data, individual files or as a live data stream. In cases where the data is received as a live data stream, the resulting aggregated representation 113 may be dynamically updated as the live data stream is received. Accordingly, if content 110A is received as a live data stream, the (potentially formatted and merged) content 110A displayed with app 114 is continually updated as new content is received in the data stream.

Method 200 further includes validating the accessed portions of content (220). Validating may include determining or verifying that the data is in an appropriate format, or is applicable to the app, good, service or other item. The validating module 106 of computer system 101 may perform the validating to ensure that the received content, whether in a live data stream or otherwise, is in an appropriate format for inclusion in the aggregated representation 113.

Method 200 also includes determining that the accessed portions of content are related to at least one version of a specified item, where the specified item is to be presented in a user interface along with the accessed portions of content from the at least two different content sources (230). Method 200 then includes merging the accessed portions of content into an aggregated representation of the specified item which is displayable in the user interface (240). The aggregated representation 113 may be displayed in a user interface 112 that is part of substantially any type of analog or digital display.

In some embodiments, the determining module 107 of computer system 101 determines relationships between the content accessed by the accessing module 105 and the items that are to be displayed in the aggregated representation. Thus, for example, if a good such as an article of clothing was to be presented in the aggregated representation 113, and content 110B was received from content source 109B, the determining module 107 would determine whether the content 110B was related to the good 115. If the content 110B was determined to be related in some way (e.g. a review for the clothing, or a set of pictures for the clothing), that content would be validated by the validating module 106 and merged by the content merging module 108 into a user-friendly representation of the content that is shown along with the good 115 in the aggregated representation 113.

Similarly, if an application such as a word processing application was to be presented in the aggregated representation 113, and content 110A was received from content source 109A, the determining module 107 would determine whether the content 110A was related to the application 114. If the content 110A was determined to be related in some way (e.g. a video review for the application, or a series of screenshots, or text describing the application from the author, or licensing information for different versions of the app), that content would be validated by the validating module 106 and merged by the content merging module 108 into a user-friendly representation of the content that is shown along with the app 114 in the aggregated representation 113. The same process may be performed for content 110C as it relates to service 116, or to any other item that may be provided for sale or otherwise provided for presentation to a user in an aggregated representation.

Each app, good, service or other item may have its own identifier. When content is aggregated and merged, the content may be aggregated and merged according to which data is related to that item's identifier. The identifier may be a static identifier such as a name or number that is universally unique. In other cases, the identifier may be a dynamic identifier or “dynamic reference” as used herein. The content may be aggregated using this dynamic reference to the specified app, good, service or other item. In some cases, the content is aggregated upon determining that at least one specified condition has occurred relative to the specified item. For example, certain portions of content may not be shown for an app such as ratings until the number of downloads has hit a certain number. Once the number of downloads has been hit, the condition has been met, and the dynamic reference begins referring the content to the app.

In some embodiments, multiple different versions of the specified item may be available, where each version includes different portions of aggregated content received from different sources (e.g. content sources 109A-109C). Each version may have its own aggregated representation. In one example, educational entities may receive a price discount and possibly a specified subset of features that is available from the full set of features. Enterprise entities may also receive certain pricing, certain features, and have the data be aggregated according to certain requirements. For instance, catalog offerings offered to end users would have the enterprise's customized look and feel, including color schemes and company logos. Thus, different content may be applied to each different version, and data for each version can coexist. For example, both versions may have user ratings, while each version has ratings that apply specifically to that version, and not to the other version. Accordingly, the aggregated representation generating module 111 may generate a different representation for each item version for display in the aggregated representation 113.

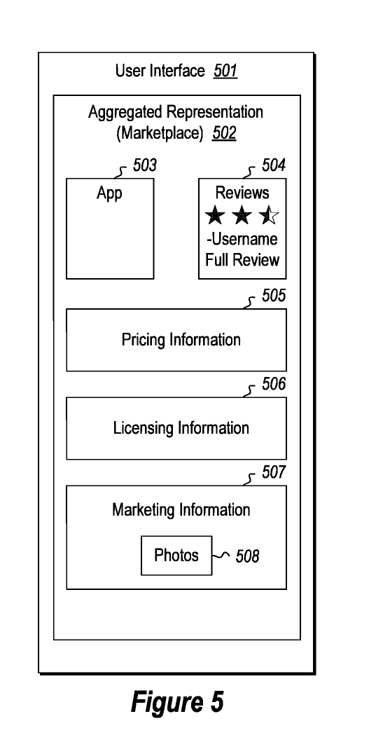

In some cases, determining that the accessed portions of content are related to at least one version of a specified item may include identifying relationships between different statically or dynamically identified media types. This may include identifying relationships between different types of data for (statically) identified pieces of content or dynamically identified pieces of content (e.g. content identified using a dynamic reference. The aggregated representation generating module 111 may then aggregate and create the aggregated representation 113, which may include a description from a developer (or goods or services provider), ratings from users, pricing from finance, licensing info from licensing, etc. All content that is determined to be related to the specified item is merged by the content merging module 108 and implemented in the aggregated representation. This is illustrated in one embodiment shown in FIG. 5. The user interface 501 includes an aggregated representation 502 which, in this example embodiment, is an application marketplace. The app marketplace 502 shows an app 503 along with reviews 504, pricing information 505, licensing information 506 and marketing information 507 which includes photos 508. It will be understood that this is just one example of aggregated content, and that many different items and types of content may be aggregated and displayed.

Software services may be implemented to correlate and aggregate different types of content including licensing, financing, ratings, pricing, marketing and other content. The software services or “processors” may be dynamically added or removed as needed to handle incoming streams of content from different content sources. In some cases, each type of content is handled by a different software service. Agents may also be used to perform any of the following: aggregating incoming content feeds, validating content format, merging content from multiple sources, formatting the portions of content and preparing the content for visualization in the user interface. Agents may also be configured to poll for new data. For instance, in cases where content is aggregated offline by saving a last known good timestamp for the content as a snapshot, the agent may listen for new content streams to come back on online.

In cases where various pieces of content conflict with one another, the determining module 107 may determine whether the conflicts are resolvable in an automated fashion (in optional step 250 of FIG. 2). The data may be analyzed to determine whether it is resolvable and how it might be resolved. For instance, if it is a simple naming change from U.S. to United States, the reconciliation is known and can be applied automatically. In cases where the conflict is more involved, a user may be notified. Still further, in some embodiments as will be explained below with regard to method 300 of FIG. 3, an exclusive lock may be implemented for cloud storage that indicates when a task has completed successfully by updating state in a cloud storage lookup table. In other cases, a non-exclusive lock may be implemented where a pool of available agents is distributed and implemented to provide the content lock.

In one specific embodiment, the computer system 101 includes two general functional pieces where the first is a system that collects or gathers data from multiple sources over a varying period of time (e.g. the data accessing module 105). This system also validates the data (e.g. using validating module 106) and stores the data in such a way that related data is stored together. These collected sets of data are marked as “unprocessed” and an entry is created in a lookup table. In one example, if “r” is the relative identifier between the sets of collected data and “x” is the number of documents, then there will be only one entry for “r” in the lookup table for every set of unprocessed data. The second piece of functionality in this embodiment is a processing service (e.g. content merging module 108) that periodically collects the related “unprocessed” data from a lookup table and then merges them together. Post merge, the merged data is stored as a “clean” copy and the unprocessed copies are removed. In this manner, data may be aggregated from a plurality of different sources in different formats and stored together for aggregation and implementation in an aggregated representation.

FIG. 3 illustrates a flowchart of a method 300 for applying exclusive locks to portions of content on distributed systems. The method 300 will now be described with frequent reference to the components and data of environment 400 of FIG. 4.

Method 300 includes receiving one or more portions of data in a data stream (310). As with the computer system 101 of FIG. 1, the computer system 401 of FIG. 4 includes a processor 402 and a memory 403. The computer system 401 also includes a communication module 404 which may be configured to receive data 408 in data stream 407. The data may include any type of data and may be received continuously or continually, depending on how the data is provided by the data source.

Method 300 further includes providing an indication to a storage device indicating that a specified function is to be performed in response to the received data (320). The indication generating module 405 of computer system 401 may be configured to generate indication 409 which is sent to storage device 410. The indication indicates that a function 411 is to be performed in response to receiving the data 408. Then, upon initiating the specified function 411, state information 413 corresponding to the specified function is updated in a data structure (330). The data structure 412 may be a lookup table or other type of data structure.

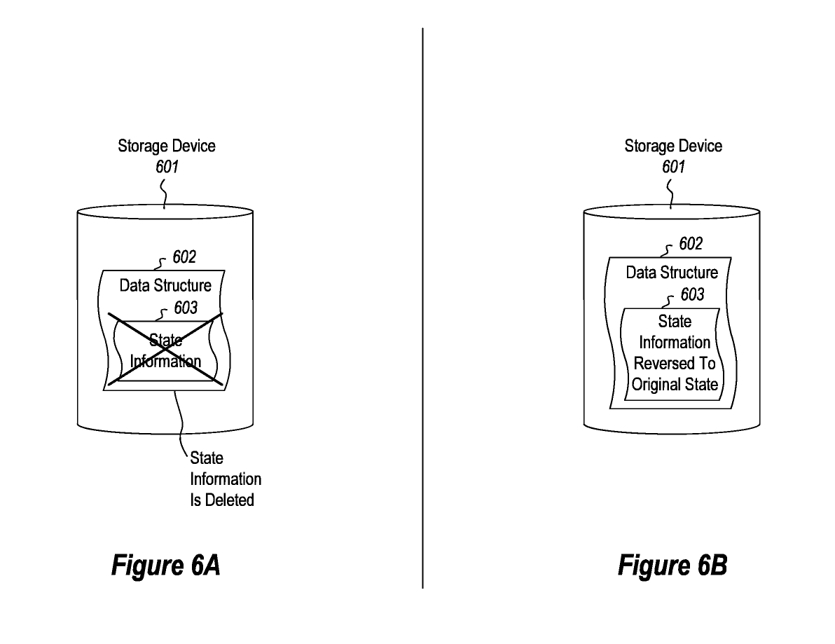

Method 300 further includes either determining that the specified function completed successfully and deleting the state information (340a), determining that the specified function failed to complete successfully and reverting the state information to its original state (340b), or determining that the specified function is in an unknown state and performing a periodic check for any entry in the data structure that has been marked for processing for more than a specified amount of time to revert the entry back to a ready state (340c). Thus, as shown in FIG. 6A, if the function completes successfully, the state information 603 inside the data structure 602 is deleted, releasing the lock on the data. And, if the function fails to complete successfully, the state information 603 is reverted back to its original state and the lock on the data remains. In this manner, an exclusive lock may be successfully applied in a distributed storage scenario.

In some cases, the data accessing module 406 of FIG. 4 may be implemented to read a specified number of records from the lookup table (i.e. data structure 412) which are in a ready state, and spin threads for each specified record that is in a ready state. The number of records selected may be a multiple of the number of currently implemented servers and the maximum desired threads per server. As such, when a server randomly attempts to lock one record per thread per server, each server may receive a maximum number of locks. In one example of this, four servers are implemented, and the number of records selected is eight (a multiple of four and the maximum desired number of threads per server). In such a case, if a server randomly attempted to lock one record per thread per server, each server would receive which its maximum number of locks and, as a result, maximum parallel processing can occur.

In one specific embodiment, a computer system collects a record from the lookup table 412 for an entity “r” and reads all “x” number of data from storage. The system updates state of “r” in the lookup table indicating that no other processing job should work on it (i.e. applies the exclusive lock in a distributed system). The computer system then starts performing the merge operation on the “x” number of data and can have three possible outcomes (340a, 340b and 340c of FIG. 3). Once this process successfully completes, the computer system deletes the entry from lookup table for “r”. If it fails, the computer system reverts the state of “r” in the lookup table for the next job to pick it up. Finally, if the process neither completes successfully nor fails, an unknown state is entered where a periodic check is performed for any entry in the lookup table that has been marked as “processing” for more than a specified amount of time. For any entries that are found at this point, the entries are reverted back to “ready” state. In this manner, distributed locks may be applied to content portions in a distributed system.

Claims Support: One embodiment includes a computer system that includes at least one processor. The computer system performs a computer-implemented method for aggregating content from a plurality of sources, where the method comprises: accessing 105 one or more portions of content 110A/110B from at least two different content sources 109A/109B, validating 106 the accessed portions of content, determining 107 that the accessed portions of content are related to at least one version of a specified item 114, wherein the specified item is to be presented in a user interface 112 along with the accessed portions of content from the at least two different content sources, and merging 108 the accessed portions of content into an aggregated representation 113 of the specified item which is displayable in the user interface.

In some embodiments, the content is aggregated using a dynamic reference to the specified item, such that the content is aggregated upon determining that at least one specified condition has occurred relative to the specified item. A plurality of versions of the specified item are available, where each version includes different portions of aggregated content received from different sources, and each version has its own aggregated representation. In some cases, determining that the accessed portions of content are related to at least one version of a specified item comprises identifying relationships between different statically or dynamically identified media types.

Still further, in some embodiments, software services are implemented to correlate and aggregate different types of content. The software services are dynamically added or removed as needed to handle incoming streams of content from different content sources. The portions of content are received as a live data stream, and the aggregated representations are dynamically updated as the live data streams are received. The method also implements an agent to perform one or more of the following: aggregate incoming content feeds, validate content format, merge content from multiple sources, format the portions of content and prepare the content for visualization in the user interface.

Another embodiment includes a computer system with at least one processor. The computer system performs a computer-implemented method for applying exclusive locks to portions of content, where the method comprises: accessing 406 one or more portions of data 408 received in a data stream 407, providing 405 an indication 409 to a storage device 410 indicating that a specified function 411 is to be performed in response to the received data, upon initiating the specified function, updating state information 413 corresponding to the specified function in a data structure 412, and performing one of the following: upon determining that the specified function completed successfully, deleting the state information 413, upon determining that the specified function failed to complete successfully, reverting the state information 413 to its original state, and upon determining that the specified function 411 is in an unknown state, performing a periodic check for any entry in the data structure 412 that has been marked for processing for more than a specified amount of time to revert the entry back to a ready state.

In some cases, the data structure in which the state information is updated is a lookup table. The method performed by the computer system reads a specified number of records from the lookup table which in a ready state, and spins threads for each specified record identifier. The number of records selected is a multiple of the number of currently implemented servers and the maximum desired threads per server, such that when a server randomly attempts to lock one record per thread per server, each server receives a maximum number of locks and maximum parallel processing can occur.

In another embodiment, a computer system is provided that includes the following: one or more processors, an accessing module 105 for accessing one or more portions of content 110A/110B from at least two different content sources 109A/109B, a validating module 106 for validating the accessed portions of content, a determining module 107 for determining that the accessed portions of content are related to a at least one version of a specified item 114, wherein the specified item is to be presented in a user interface 112 along with the accessed portions of content from the at least two different content sources, and a content merging module 108 for merging the accessed portions of content into an aggregated representation 413 of the specified item which is displayable in the user interface.

In some cases, portions of content are aggregated offline by saving a last known good timestamp for the content as a snapshot, and listening for content streams to come back on online. The method also includes analyzing the content received from the at least two different content sources to determine whether content conflicts exist and, if so, whether the conflicts are resolvable in an automated fashion.

Accordingly, methods, systems and computer program products are provided which aggregate content from a plurality of sources. Moreover, methods, systems and computer program products are provided which apply exclusive locks to portions of content on distributed systems.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for aggregating content from a plurality of sources, the method comprising:
accessing one or more portions of content from at least two different content sources;
validating the accessed portions of content;
determining that the accessed portions of content are related to at least one version of a specified item, wherein the specified item is to be presented in a user interface along with the accessed portions of content from the at least two different content sources; and
merging the accessed portions of content into an aggregated representation of the specified item which is displayable in the user interface.

2. The method of claim 1, further comprising displaying the aggregated representation in the user interface.

3. The method of claim 1, wherein the content is aggregated according to which data is related to a specified static item identifier.

4. The method of claim 1, wherein the content is aggregated using a dynamic reference to the specified item, such that the content is aggregated upon determining that at least one specified condition has occurred relative to the specified item.

5. The method of claim 1, wherein a plurality of versions of the specified item are available, each version including different portions of aggregated content received from different sources, each version having its own aggregated representation.

6. The method of claim 1, wherein determining that the accessed portions of content are related to at least one version of a specified item comprises identifying relationships between different statically or dynamically identified media types.

7. The method of claim 1, further comprising implementing one or more software services to correlate and aggregate different types of content.

8. The method of claim 7, wherein the software services are dynamically added or removed as needed to handle incoming streams of content from different content sources.

9. The method of claim 7, wherein each type of content is handled by a different software service.

10. The method of claim 1, wherein the one or more portions of content are received as a live data stream, the aggregated representations being dynamically updated as the live data streams are received.

11. The method of claim 1, further comprising implementing an agent to perform one or more of the following: aggregate incoming content feeds, validate content format, merge content from multiple sources, format the portions of content and prepare the content for visualization in the user interface.

12. At a computer system including at least one processor, a computer-implemented method for applying exclusive locks to portions of content, the method comprising:
accessing one or more portions of data received in a data stream;
providing an indication to a storage device indicating that a specified function is to be performed in response to the received data;
upon initiating the specified function, updating state information corresponding to the specified function in a data structure; and
performing one of the following:
upon determining that the specified function completed successfully, deleting the state information;
upon determining that the specified function failed to complete successfully, reverting the state information to its original state; and
upon determining that the specified function is in an unknown state, performing a periodic check for any entry in the data structure that has been marked for processing for more than a specified amount of time to revert the entry back to a ready state.

13. The method of claim 12, wherein the data structure in which the state information is updated comprises a lookup table.

14. The method of claim 13, further comprising reading a specified number of records from the lookup table which in a ready state, and spinning threads for each specified record identifier.

15. The method of claim 14, wherein the number of records selected is a multiple of the number of currently implemented servers and the maximum desired threads per server, such that when a server randomly attempts to lock one record per thread per server, each server receives a maximum number of locks and maximum parallel processing can occur.

16. The method of claim 12, wherein an exclusive lock is successfully achieved if the state information update was successful, and wherein the exclusive lock fails if the state information update was unsuccessful.

17. A computer system comprising the following:
one or more processors;
one or more computer-readable storage media having stored thereon computer-executable instructions that, when executed by the one or more processors, cause the computing system to perform a method for aggregating content from a plurality of sources, the method comprising the following:
accessing one or more portions of content from at least two different content sources;
validating the accessed portions of content;
determining that the accessed portions of content are related to a at least one version of a specified item, wherein the specified item is to be presented in a user interface along with the accessed portions of content from the at least two different content sources; and
merging the accessed portions of content into an aggregated representation of the specified item which is displayable in the user interface.

18. The computer system of claim 17, wherein one or more portions of content are aggregated offline by saving a last known good timestamp for the content as a snapshot, and listening for content streams to come back on online.

19. The computer system of claim 17, further comprising implementing an exclusive lock for cloud storage that indicates when a task has completed successfully by updating state in a cloud storage lookup table.

20. The computer system of claim 17, further comprising analyzing the content received from the at least two different content sources to determine whether content conflicts exist and, if so, whether the conflicts are resolvable in an automated fashion.
